(19) United States
(12) Patent Application Publication
(10) Pub. No.: US 2015/0202837 A1
(43) Pub. Date: Jul. 23, 2015

(54) REINFORCED RUBBERISED TRANSPORT SYSTEMS

(71) Applicant: Frederick James COETZEE, (US)

(72) Inventor: Frederick James Coetzee, Durban (ZA)

(21) Appl. No.: 14/421,290

(22) PCT Filed: Aug. 12, 2013
(86) PCT No.: PCT/ZA2013/000064

§ 371 Date: Feb. 12, 2015

(30) Foreign Application Priority Data
Aug. 15, 2012 (ZA) 2012/06124

(51) Int. Cl. B32B 5/12; B29D 29/06; B32B 5/02; B29D 29/00

(52) U.S. Cl. CPC B32B 5/12; B29D 29/00; B29D 29/06; B32B 5/028; B29K 2021/006

(57) ABSTRACT

An aramid carcass highly bondable to vulcanized rubber, and which includes a multiaxial composite fabric made of layers of parallel yarns laid in different orientations layer-by-layer and stitched together, the layers of the yarn creating a mesh like fabric through which vulcanized rubber can penetrate, the multiaxial composite fabric treated with RFL (Resorcinol Formaldehyde Latex) adhesive.

### TECHNICAL FIELD OF THE INVENTION

This invention relates to a reinforced rubberised conveyor carcass.

### BACKGROUND ART

There are a variety of reinforced carcass systems used for manufacturing conveyor belting. These systems traditionally consist of reinforcing components including steel or textile composites which are aligned only along the length and across the width direction of the belting.

These existing rubberised systems generally result in very heavy or thick belts which are energy inefficient, and difficult to join (splice) resulting in prolonged downtimes, they also have limited impact resistance and it is often difficult to achieve good tracking ability of the belts without damaging the belt edges.

The significant rise in energy costs worldwide has meant that heavy steel reinforced carcasses are no longer viable. Textile carcasses are much lighter and large savings can be achieved in running costs by adopting these carcasses.

This requirement to reduce running costs has resulted in the advent of aramid yarns which are light and still have similar strength characteristics to steel. Aramid carcasses encased in rubber have been available on the market for many years specifically for the tyre and conveyor industries.

However, problems are faced with these aramid carcasses in that the rubber casings do not adhere to the aramid carcass sufficiently, resulting in reduced peel strength. In addition, splicing strengths of these carcasses are not optimal.

It is an object of this invention to provide a reinforced rubberised transport system which, at least partially, alleviates some of the abovementioned problems.

### SUMMARY OF THE INVENTION

In accordance with this invention, there is provided an aramid carcass highly bondable to vulcanised rubber comprising;
A multiaxial composite fabric made of layers of parallel aramid yarns laid in different orientations, layer-by-layer and stitched together,
the different orientations of the layers of yarn creating a mesh-like fabric, through which vulcanised rubber may penetrate
the fabric being treated with RFL (Resorcinol Formaldehyde Latex) adhesive.

The fabric is preferably quadriaxial, with four layers of parallel fibres being laid in four directions and stitched together.

The layers of yarn of the quadriaxial fabric are preferably oriented at 0°, +45°, 90° and −45°. The apertures in the mesh between the various strands of yarn are preferably between 2 mm×2 mm and 10 mm×10 mm in size.

As the maximum strength is required in the longitudinal axis (0 Degree) of the fabric, this direction may have a higher aramid yarn content than the other directions.

The yarn content and even the angles of the yarns may be varied according to the engineering requirements for the final reinforced carcass.

The invention further extends to a method of manufacturing a rubber reinforced aramid carcass, the method comprising the steps of;
placing layers of parallel aramid yarns in different orientations, one on top of the other layer-by-layer and stitching the layers together to form a mesh like fabric,
treating the fabric with RFL (Resorcinol Formaldehyde Latex) adhesive,
subjecting the RFL treated fabric to vulcanised rubber, and allowing the rubber to penetrate through the holes in the mesh like fabric.

By significantly altering the angles of aramid yarns in the carcass the carcass is improved for rubber reinforcing to give better splicing strengths, reduce splicing failures, improve impact resistance and improve the tracking ability of belts.

### BRIEF DESCRIPTION OF THE DRAWINGS

A preferred embodiment of the invention is described below by way of example only and with reference to the following photograph, in which;

FIG. 1 is a representation of the multi axial composite material.

### DETAILED DESCRIPTION OF THE INVENTION

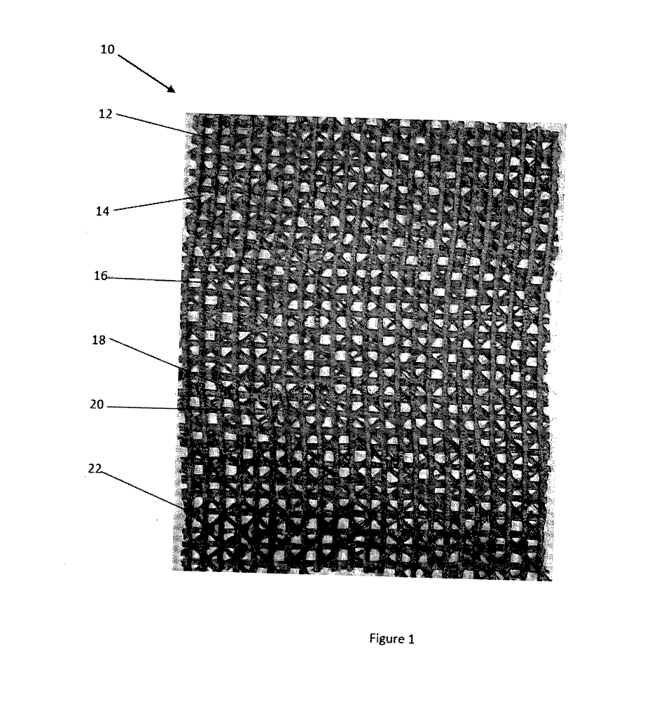

Referring to FIG. 1, the construction of the multiaxial composite mesh like fabric 10 is clearly visible with the aramid yarn 12 in multiple directions to create the apertures 14 for rubber impregnation.

The layers of yarn of the quadriaxial fabric are preferably oriented at 0° (16), +45° (18), 90° (20) and −45° (22).

The apertures 14 in the mesh between the various strands of yarn (16, 18, 20, and 22) are generally between 3 mm and 8 mm in size.

The multiaxial composite mesh like fabric 10 is treated with RFL to ensure that it bonds with rubber, after which rubber is vulcanised onto the carcass.

By changing the angles and directions of the aramid textile composite structure, many additional benefits are added to the “conventional” systems that are currently in use. The product displays the following attributes:
Light weight high strength constructions
Automatic tracking ability
Improved impact resistance with textile reinforcing covering more angles than a simple woven carcass.

Improved splicing and better splicing strengths
Extended life of conveyor belts due to more balanced construction.
Excellent peel strengths due to rubber penetrating through the ensemble. locking the entire carcass together.

The final product may be as a reinforcing composite structure in rubber applications such as tyres, conveyor belting, pipes, and diaphragms.

Numerous modifications to this embodiment are possible, without departing from the scope of the invention.

The invention therefore provides a novel reinforced rubberised conveyor carcass.

1-9. (canceled)

10. An aramid carcass highly bondable to vulcanized rubber, comprising:
a multiaxial composite fabric made of layers of parallel yarns laid in different orientations, layer-by-layer and stitched together, the layers of the yarn creating a mesh like fabric through which vulcanised rubber can penetrate; the multiaxial composite fabric being treated with RFL (Resorcinol Formaldehyde Latex) adhesive.

11. The aramid carcass as claimed in claim 10, wherein the fabric is quadriaxial with four layers of parallel fibres being laid in four directions and stitched together.

12. The aramid carcass as claimed in claim 11, wherein the layers of yarn of quadriaxial fabric are orientated at 0°, +45°, 90° and −45° relative to the longitudinal axis of the fabric.

13. The aramid carcass as claimed in claim 11, wherein apertures between the various strands of yarn of quadriaxial fabric are preferably between 2 mm×2 mm and 10 mm×10 mm in size.

14. The aramid carcass as claimed in claim 10, wherein maximum strength is required in the length (0°) of the quadriaxial fabric and this direction comprising a higher aramid yarn content than the other directions.

15. The aramid carcass as claimed in claim 10, wherein the yarn content and even angles of the yarn is varied depending on the engineering requirements for the final reinforced carcass.

16. The aramid carcass as claimed in claim 10, wherein the aramid carcass is used as reinforcing in rubber applications including conveyor belting, tyres, piping and diaphragms.

17. A method of manufacturing of a rubber reinforced aramid carcass wherein the method comprises the steps of:
placing the layers of parallel aramid strands of yarn in different orientations, one on top of the other layer-by-layer and stitching the layers together to form a mesh like fabric;
treating the fabric with RFL (Resorcinol Formaldehyde Latex) adhesive; and
subjecting the RFL treated fabric to vulcanised rubber and allowing the rubber to penetrate through the holes in the mesh like fabric.

18. A method of manufacturing of a rubber reinforced aramid carcass as claimed in claim 17, wherein by altering the angles of the strands of aramid yarn the carcass is improved for rubber reinforcing to give better splicing strengths, reducing splicing failures, improving impact resistance and improving the tracking ability of belts.
